(19) United States
(12) Patent Application Publication
(10) Pub. No.: US 2019/0073716 A1
(43) Pub. Date: Mar. 7, 2019

(54) Systems, Administration, and Methods for Trading And Converting Structured Tax-Exempt Municipal Bond Pools

(71) Applicant: Kemp Lewis, New York, NY (US)

(72) Inventor: Kemp Lewis, New York, NY (US)

(21) Appl. No.: 15/879,244

(22) Filed: Jan. 24, 2018

Related U.S. Application Data
(60) Provisional application No. 62/553,407, filed on Sep. 1, 2017.

(51) Int. Cl. G06Q 40/04

(52) U.S. Cl. CPC G06Q 40/04

(57) ABSTRACT

The disclosure relates to structures and methods for securitization of tax-exempt bonds and loans by a non-municipal originator. The structures and methods are constructed in such a way to create tax-exempt status for the interest on newly-issued debt instruments, thereby enhancing the efficiency of prior financial structures and mechanisms. The methods involve an issuer authorized to issue tax-exempt bonds issuing debt instruments secured and paid by pooled tax-exempt bonds and/or loans purchased from a non-municipal entity. The issuer or another municipality retains an equity interest in the pooled bonds.

### CROSS-REFERENCES TO RELATED APPLICATIONS

This application is entitled to priority to U.S. provisional patent application No. 62/553,407 filed Sep. 1, 2017.

### BACKGROUND OF THE DISCLOSURE

The invention relates generally to the field of securitization of financial instruments. Municipal bonds have historically been offered through limited vehicles with no true tax-exempt collateralized debt obligation (CDO) transactions executed. Therefore, a need exists for a securities distribution engine, and, more particularly, for systems and methods for trading and converting structured tax-exempt municipal bond pools.

### BRIEF SUMMARY OF THE DISCLOSURE

The subject matter described herein relates to a method for managing securitization of tax-exempt bonds. The method includes a step in which at least one tax-exempt bond is assigned to a pool, each pooled bond being originally owned by a non-municipal originator. The issuer may be a municipality or other governmental entity that is authorized to issue tax-exempt bonds. A proposed Structured Tax-Exempt Municipal Pool (STEMP) series may be generated, in which the proposed (or “indicative”) STEMP series will include at least one equity tranche and at least one debt tranche. The proposed STEMP series may, for example i) define the par value for each equity and debt tranche, ii) define a payment hierarchy among the equity and debt tranches, and iii) include a sale price for each equity and debt tranche. The sum of the sale prices for all tranches would be the issue price. The payment hierarchy specifies entitlement of each equity and debt tranche to proceeds derived from the pooled bonds, the equity tranche being entitled to the residuum which remains after entitlements to the proceeds have been satisfied for all debt tranches. In the method, each originator may be obligated to sell the pooled bonds to an issuer for a purchase price. The method also provides that at least one non-municipal investor may purchase, at the corresponding sale price, at least a portion of at least one debt tranche not later than a sale closing date. At least one municipal investor may be obligated to retain at least a portion of at least one equity tranche not later than the sale closing date. Not later than an issue closing date, the issuer is obligated to issue the STEMP series to the municipal and non-municipal investors.

Numerous variations of this method are possible. For example, the issuer may act as a municipal investor in addition to acting as the issuer. The purchase closing date, and the sale closing date, for example, may all be the same date, if desired. As part of this method, A) sale of the pooled bonds by each originator to the issuer on the purchase closing date and B) sale of each debt tranche of the STEMP series by the issuer to each non-municipal investor on the sale closing date may each be performed by a broker-dealer. Some or all of the pooled bonds originally may be owned by a single originator. An originator can also act as a non-municipal investor, purchasing STEMP series debt obligations that securitize the pool of tax-exempt bonds that were sold by such originator to the issuer at the inception of the transaction. An opinion of counsel may be secured, attesting that at least one debt tranche is issued in the form of a tax-exempt bond.

The method may be embodied in a computerized system for managing securitization of tax-exempt bonds. Such a system may include a non-transient memory storage and at least one computer processor configured to i) receive and store in the storage data corresponding to a plurality of tax-exempt bonds, the data including, for each bond, a) the identity of the bond and a municipality which issued it, b) data confirming the bond is a tax-exempt bond, and c) the identity of a non-municipal originator which owns the debt obligation; ii) receive and store in the storage a proposed STEMP series including at least one equity tranche and at least one debt tranche, the proposed STEMP series a) defining the par value for each equity and debt tranche, b) defining a hierarchy among the equity and debt tranches, and c) including a sale price for each equity and debt tranche; iii) receive and store in the storage a sale price for each equity and debt tranche, the sum of the sale prices of all equity and debt tranches being the issue price; iv) display to at least one non-municipal investor the sale price for at least a portion of at least one debt tranche; v) display to at least one municipal investor the sale price for at least a portion of at least one equity tranche; vi) receive and store in the storage offers from investors to purchase portions of the debt and equity tranches; and vii) calculate the portions of each of the debt and equity tranches for which offers have been received. The system may be further configured to manage multiple distinct rounds of securitization of discretely-pooled tax-exempt bonds.

### BRIEF SUMMARY OF THE SEVERAL VIEWS OF THE DRAWINGS

FIG. 1 is a diagram which illustrates the methods and structures described herein. In FIG. 1, an issuer (“ISSUER”) authorized to issue tax-exempt bonds purchases a diversified pool of tax-exempt municipal bonds from one or more originators. Upon purchasing the diversified pool of tax-exempt municipal bonds, the issuer issues a STEMP series of debt and equity obligations, including one or more tranches of debt obligations (i.e., tax-exempt bonds) and at least one equity tranche (here, retained by the issuer, as indicated by the line connecting the two). In the example illustrated, the STEMP series includes an equity tranche and four tranches of debt obligations.

FIG. 2 is a diagram which illustrates the structure of a STEMP series. As shown in this example, a STEPM series can include an equity tranche and multiple debt tranches, with the most senior debt tranche in this example subdivided into different maturities with repayment periods of 5, 10, and 30 years.

### DETAILED DESCRIPTION

The subject matter described herein relates to collateralization of debt obligations secured by and paid from pools of existing tax-exempt bonds or loans. A governmental conduit issuer acts as a special purpose vehicle equivalent, allowing newly-created debt instruments to also be sold as tax-exempt municipal bonds (a “STEMP series” of bonds; STEW is an acronym for a structured tax-exempt municipal bond pool).

As used herein, each of the following terms has the meaning associated with it in this section.

The term “municipality” or “municipal entity” means a government entity such as a state, territory, district, county, parish, city, town or village, or an agency, department, public authority, or public benefit corporation created by a government entity, or any other entity permitted under U.S. federal law to issue tax-exempt bonds.

A “municipal investor” is an investor which is a municipality.

A “non-municipal entity” is an entity that is not a municipality.

An “issuer” is a municipal entity whose debt and/or equity obligations are sold to or placed with investors in a primary market transaction in exchange for money received from investors.

An “investor” is an entity or person that owns the debt and/or equity obligations of an issuer.

An “originator” is an investor who sells one or more pre-existing tax-exempt bonds to an issuer.

The term “tax-exempt bond” means an interest-bearing and/or interest-accreting debt obligation, which could be a bond, a certificate of participation, a warrant, a loan or any other debt instrument, the interest of which is generally not subject to federal income taxation under U.S. law.

The term “STEMP series” means a plurality of debt and equity obligations that: (i) include multiple tranche classes, including at least one equity tranche and one debt tranche of tax-exempt bonds, the equity tranche being entitled to the residuum which remains after the obligations with respect to all debt tranches have been satisfied. (ii) are issued by a municipality, and (iii) are secured by and paid from one or more tax-exempt bonds held in trust, which are sold to the issuer by a non-municipal investor.

A municipality “issues” a tax-exempt bond when the municipality receives upfront payments from one or more investors in exchange for executing an obligation to the investor(s) (i) to repay the principal no later than a specified maturity date and (ii) to pay a specified amount of interest on the principal at one or more specified dates. The tax-exempt bond may be secured by an indenture of trust or a similar contract, by a resolution of the municipality or by other statutory or contractual means.

The subject matter described herein relates to collateralization of debt obligations secured and paid by pools of existing tax-exempt bonds or loans. A governmental issuer acts as a special purpose vehicle equivalent, allowing newly-formed debt instruments to also be sold as tax-exempt municipal bonds (a “STEMP series” of bonds; STEMP is an acronym for a structured tax-exempt municipal bond pool). The securitization can, for example, be motivated by the interest of a current investor in existing tax-exempt bonds or loans, such as when that investor desires to liquidify or cease its investment. Issuing newly formed instruments (i.e., the STEMP series) using the methods described herein as primary market tax-exempt municipal bonds may eliminate the inefficiencies of pass-through structures (e.g., corporate trusts holding bond/loan pools) used in past municipal securitizations and can also avoid regulatory burdens associated with securitizations that are not issued by municipalities. Thus, the subject matter herein improves the efficiency and functioning of financial securitization mechanisms in a manner in which innovative software can improve the efficiency and functioning of computers.

A primary benefit of the methods and structures described herein is that they can increase market value by using cash flows from a diversified pool of lower- or non-rated municipal securities to support credit and time-tranched securities in which senior tranches are rated in high investment grade categories. Other uses of the subject matter described herein are to create liquidity for illiquid bond and loan positions, and to leverage positions by selling higher-rated tranches and retaining concentrated credit and prepayment risks in the lower tranches. Alternatively, methods and structures described herein may be used to sell lower-rated tranches and retain higher rated tranches. These methods and structures would help to improve the functioning of financial markets and represent important technological advances for achieving such improved function.

The methods and structures described herein can be used repeatedly to generate multiple, distinct pools of tax-exempt bonds/loans, each securitized in the form of a STEMP series of tax-exempt municipal bonds. Each standalone STEMP series can be secured by a static and unique pool of fixed rate tax-exempt bonds or loans sold to the issuer of the STEMP series by an “originating investor.” Examples of such originating investors are bond funds, insurance companies and banks that have portfolios of high yield tax-exempt bonds or loans.

It has long been possible to securitize existing debt obligations, including tax-exempt municipal bonds and/or municipal loans (hereinafter simply referred to as “municipal bonds”). However, a significant drawback and inefficiency of the financial system, prior to the invention described herein, was that securitization of tax-exempt municipal bonds did not completely pass-through the tax-exempt status of the underlying municipal bonds to the securitization bonds secured by such underlying municipal bonds. Using the structures and method described herein, these instruments can be securitized while retaining that tax advantage—a significant improvement. Using the structures and method described herein, tax-exempt municipal bonds are purchased by governmental issuer and that issuer issues new tax-exempt municipal bonds—optionally stratified by risk—and an equity tranche as a STEMP series of debt and equity obligations. Structuring the sale of pre-existing tax-exempt municipal bonds and issuing new ones through a governmental issuer: (i) allows the creation of new tax-exempt interest bearing bonds, without having to preserve the divisions between principal and interest on the underlying assets; and (ii) permits the newly-issued municipal securities to be exempt from registration by right from the securities laws, broadening distribution versus a SEC Rule 144A offering, and exempting the newly-issued municipal securities from most securitization requirements imposed under legislation and rules generally referred to in this field as Dodd-Frank regulations.

The STEMP series may be structured, as one example, as closed cash collateralized bond obligations (“CBOs”). Each STEMP series may be composed of a static pool of fixed rate tax-exempt bonds that may be in the trust at closing and remain unchanged until all the underlying bonds mature or are redeemed. Multiple STEMP series can be issued in separate transactions, each transaction relating to a separate pool of pre-existing tax-exempt municipal bonds. This structure facilitates elimination of cross-collateralization among transactions (or between STEMP series). Other STEMP structures could allow for cross-collateralization.

The structures and method described herein may have particular value to originators which hold pre-existing tax-exempt municipal bonds, such as tax-exempt bond funds, insurance companies, banks having tax-exempt loan portfolios, municipal leasing companies, and specialty lenders involved with charter schools, multifamily housing providers, healthcare systems and private colleges or other municipal borrowing sectors. The ability of the structures and method described herein to preserve the tax-exempt benefit of the municipal bonds underlying each STEMP series can make securitization of those bonds practically feasible, even though such securitization was infeasible using previously known methods and structures. This value can, for example, induce originators to bear some or all of the acquisition costs, carry costs, hedging costs, and/or risks associated with the issuer (or its underwriter) acquiring the pools of pre-existing municipal bonds involved in the transactions described herein.

The structures and methods described herein also have value in credit arbitrage situations, in which the cash flows from a diversified pool of lower- and non-rated municipal securities can be used to support credit- and time-tranched securities (e.g., tax-exempt bonds of a STEMP series) in which the most senior tranches, representing most of the capitalization, are rated in the high investment grade categories. The value of the transactions described herein can be thought of as the difference between the market value of the pre-existing tax-exempt municipal bonds (i.e., if sold as discrete credits or entities) and the combined sales prices of the STEMP series debt and equity obligations, less transaction costs. This value derived can be apportioned among the originator(s), the issuer, the investors in the STEMP series, and one or more facilitators (e.g., an underwriter or other financial facilitator) in a variety of ways. By way of example, this value can be returned to the originator(s) if the pre-existing municipal bonds are purchased in exchange for the net proceeds derived from sale of the STEMP series.

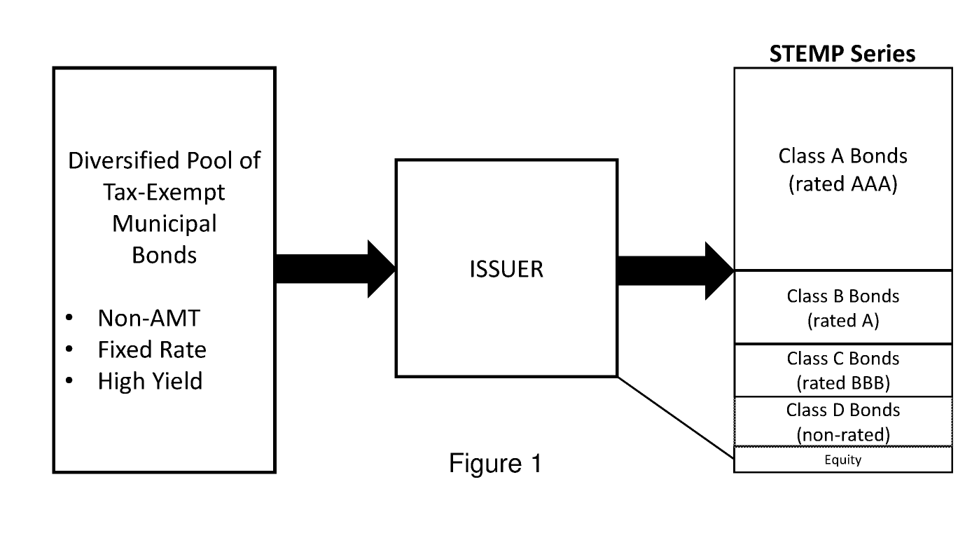

FIG. 1 illustrates an example of the methods and structures described herein. In FIG. 1, an issuer authorized to issue tax-exempt bonds purchases a diversified pool of tax-exempt municipal bonds from one or more originators. In this example, the purchase price for the diversified pool of bonds can be the net proceeds received from the sale of STEMP series bonds from the issuer to investors. Upon purchasing the diversified pool of tax-exempt municipal bonds, the issuer issues a STEMP series of debt and equity obligations, including one or more tranches of debt obligations (i.e., tax-exempt bonds) and at least one equity tranche. In the example illustrated, the STEMP series includes an equity tranche and four tranches of debt obligations, designated classes A-D. Class A debt obligations are bonds rated AAA, and Classes B and C are bonds rated A and BBB, respectively. Class D debt obligations are non-rated bonds. In this example, investors (which can be all new investors or, alternatively, which can include one or more originators and/or the issuer) purchase all of the debt tranches of the STEMP series from the issuer, and the issuer pays the originator(s) for the diversified pool from the proceeds of those sales. The diversified pool of tax-exempt municipal bonds from the originator(s) are, for example, held in trust by the issuer for the benefit of the holders and beneficial owners of the tranches of the STEMP series. For example, the pooled bonds may be held in a bankruptcy-remote trust estate of the issuer for the benefit of owners of the STEMP series obligations.

Further aspects of the participants, components, and practice of the STEMP transactions disclosed herein are described in the following sections.

The Facilitator

The STEMP transactions described herein can be, and preferably are, coordinated by a facilitator, such as a financial services firm experienced with underwriting and offering of financial securities. The facilitator can perform one or more functions to coordinate the transaction, including one or more of coordinating with one or more originators regarding the pre-existing tax-exempt municipal bonds to be pooled and involved in the STEMP transaction, coordinating with one or more investors (potentially including an originator, the issuer, or the facilitator) to purchase STEMP debt or equity obligations in a STEMP debt or equity tranche, coordinating with an issuer to issue STEMP debt and equity obligations, and coordinating with financial service providers (e.g., underwriters, structuring advisers, legal counsel, for example). A full-service financial underwriting firm is an example of a suitable facilitator.

In one embodiment, the facilitator enters into binding contracts with both the originator(s) (to sell the pre-existing tax-exempt municipal bonds on/by a first closing date) and the investor(s) who purchase STEMP debt obligations or shares of them (to purchase debt obligations or shares on/by a second closing date, which may be the same as the first) and also works with a qualified governmental issuer to accept the pre-existing bonds and issue the STEMP debt obligations on appropriate date(s).

The facilitator can work substantially independently of all of the originator(s), the investor(s), and the issuer, but typically coordinates closely with at least one of these. By way of example, the facilitator may work closely with one or more originators who wish to securitize pre-existing tax-exempt municipal bonds held by them. In this instance, the facilitator may, in effect, assist the originator(s) to transfer the bonds to a trust (e.g., one created by the issuer) and to find investors to purchase STEMPs payable from the trust. Alternatively, a facilitator can work with investors seeking to purchase, for example, highly-rated debt tranches securitizing a pool of credit-worthy municipal bond obligations.

The Originator(s)

In one embodiment, the originator(s), all of whom are non-municipal entities, receive the proceeds from the sale of the STEMP series, less transactions costs, in exchange for transferring the pooled tax-exempt municipal bonds to the issuer at closing. Preferably, the total sales price for all of the STEW series obligations (i.e., the issue price), less transaction costs and less any issuer retained equity, should be greater than the value of the pooled bonds if those pooled bonds were sold (individually or in a group) in the secondary market as independent municipal bonds. Under such circumstances, the transaction will ordinarily prove beneficial for the originator(s). Put another way, the transaction can be expected to be attractive to originators when they receive from the issuer an amount greater than the market value a the pooled bonds, valued independently.

By way of example, a portfolio of fixed rate tax-exempt bonds may be sold by an originating investor to an issuer in exchange for all or a portion of the net proceeds from the sale of STEMP series instruments (sale price reduced by transaction costs). The originator may purchase any portion of the STEMP series instruments. As owner of a pool of existing municipal securities, the originator may be, practically speaking, the driver of the transaction and may make all major decisions as to structure, timing and execution. The structures and methods described herein allow for flexible structuring of the STEMP series to adapt to characteristics of the assets, market conditions, the originating investor's goals, or other factors.

The Pooled Tax-Exempt Bonds

The methods and structures described herein involve pooling multiple tax-exempt municipal bonds. Such bonds include both bonds issued by municipal government entities for their own use and private activity bonds authorized by municipal government for use by certain non-government entities (e.g., charter schools, multifamily housing providers, healthcare systems, and private colleges). The exact nature of such bonds is not critical, and such bonds may be interest-bearing or interest-accreting debt obligations (which could have the formal structure of a bond, a certificate of participation, a warrant, a loan, or another debt instrument), the interest of which is generally not subject to federal income taxation under U.S. law.

Pooled tax-exempt municipal bonds may include bonds issued by multiple (e.g., 35 to 100) distinct municipal entities, with no bond exceeding 5% of the total value of the pool. The ratings, if any, assigned to the pooled bonds are likewise not critical. In some embodiments, it is anticipated that few of the pooled bonds will be rated more favorably than BBB. Many of the pooled bonds may be unrated. Rating agencies may assign ratings to unrated bonds in the pool, and these shadow ratings may not be public.

The pooled tax-exempt municipal bonds may include governmental bonds such as those issued to finance governmental projects (e.g., schools and roads) and/or secured by governmental revenues (e.g., bonds secured by and paid from generally applicable taxes, such as sales taxes).

The pooled tax-exempt municipal bonds may also include government-authorized private activity bonds. Examples of private activity bonds expected to be commonly pooled include bonds issued to fund charter schools, multifamily housing, healthcare systems and private colleges. Other pooled bonds could include those intended to fund retirement homes and student housing. Although the best rating results for STEMP series debt obligations may result from highly diversified portfolios, it is possible that there could be asset concentrations including, for example, a pooled bond portfolio composed of only bonds for charter schools.

Qualified 501(c)(3) bonds are one type of private activity bonds issued for qualified projects of not-for-profit corporations, and these can also be pooled, so long as they are properly considered tax-exempt municipal bonds. For example, qualified projects of healthcare systems, multi-family housing, private colleges, charter schools, retirement homes, museums and other not-for-profits can be financed tax exempt as qualified 501(c)(3) bonds. Qualified 501(c)(3) bonds are the most prevalent type of tax-exempt private activity bond that is not generally subject to the Alternative Minimum Tax (AMT). Other types of private activity bonds can qualify for tax exemption, but should not be pooled as described herein because they are subject to the AMT under current tax law. These include exempt facility bonds for airports and port facilities, qualified mortgage revenue bonds that were issued prior to mid-2008 (and therefore subject to the AMT), and qualified student loan bonds. Generally speaking, though under current tax law any tax-exempt bond or loan that is not generally subject to the AMT is eligible collateral for use as a pooled tax-exempt municipal bond, as that term is used in connection with the methods and structures described herein.

The STEMP Series

The series of debt and equity obligations issued by an issuer and corresponding to a discrete set of pooled tax-exempt municipal bonds is referred to herein as a “STEMP series.” The pooled bonds purchased by the issuer from a non-municipal investor are held in trust as collateral for the corresponding STEMP series. The STEMP series includes at least one debt tranche and at least one equity tranche. However, beyond that, a variety of structures are possible.

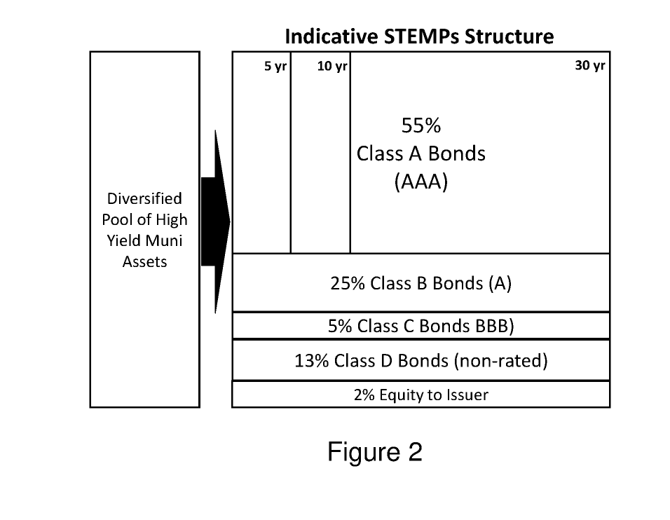

One beneficial structure is a STEMP series which includes multiple debt tranches, with the various debt tranches differentiated from one another by, for example, the perceived or rated creditworthiness of the tranches, the expected repayment period, the interest rate offered, or a variety of these factors. By way of example, one or more debt tranches can be rated by known credit-rating organizations, and one or more debt tranches can remain unrated. For example, as shown in FIG. 2, the STEMP series can include an equity tranche and multiple debt tranches, with the most senior debt tranche subdivided into different maturities with repayment periods of 5, 10, and 30 years. Various STEMP series hierarchies may have three or more debt tranches with most of them being highly rated, for example. Either or both of credit and pre-payment risks for the pooled bonds may be concentrated in the lower-rated debt tranches or in an equity tranche.

In the STEMP series, a hierarchy is defined among the equity and debt tranches. The hierarchy specifies entitlement of each equity and debt tranche (or each mautiry of each tranche, if one or more tranches include multiple maturities) to proceeds derived from the pooled tax-exempt municipal bonds corresponding to the STEMP series, including both interest and principal payments corresponding to the pooled bonds. Because the hierarchy of the STEMP series defines this entitlement, active management of the pooled bonds and the STEMP series may not be necessary, although some STEMP issues may be actively managed.

Typically, the STEMP series hierarchy will define one or more equity tranches, and these equity tranches will be defined as being entitled to the residuum which remains after entitlements to the proceeds of the pooled bonds have been satisfied for all debt tranches. Because they are sold by an issuer authorized to issue tax-exempt municipal bonds, the STEMP series debt obligations are, themselves, tax-exempt municipal bonds. The STEMP series obligations are not, by comparison with previously-known structures, equity participation certificates (like certificates issued in known tax-exempt CDOs) or debt of a corporate trust (like most corporate CDOs). Because all of the net proceeds generated by the sale of the STEMP series debt obligations are invested in tax-exempt debt, interest on those STEMP series debt obligations will ordinarily be exempt from federal taxation under US law. Couponing of STEMP series debt and equity obligations can be based on market conditions at the time of closing without regard to the tax-exempt interest patterns on the underlying pooled bonds.

Structuring the STEMP series debt obligations as new tax-exempt municipal securities issued through a municipal issuer with the legal right to issue tax-exempt bonds is an important aspect of the structures and methods described herein.

A universal tenet of U.S. securitizations, both taxable and tax-exempt, is that the IRS will recognize securities secured by a fixed set of cash flows as debt, but only if there is a residual tranche that is equity. This is an important reason why the STEMP series must include an equity tranche.

Under current tax law, the equity tranche of the STEMP series must remain held by a municipal entity authorized to issue tax-exempt bonds in order for the tax exemption to remain applicable to the STEMP series. For this reason, it is important that the equity tranche remain held by such a municipal entity as long as the associated STEMP series remains outstanding. That equity tranche should therefore not be sold, directly or through beneficial interests, to a private investor at closing or at any time thereafter. For example, a residual equity tranche of at least 2% of the total value of the STEMP series securities may be held by the issuer to allow the balance of the STEMP series securities to remain tax exempt.

As municipal securities, the obligations of the STEMP series are likely exempt from most rules and procedures for asset-backed securities put in place to implement the Dodd-Frank Act, including credit risk retention requirements. It may nonetheless be advantageous, in order to ensure compliance with protocols that govern the relationships between rating agencies and issuers of asset-backed bonds, to set up a (e.g., internet-based) workroom to store all transaction related documentation for the life of the assets involved in the transactions described herein.

It may be advantageous to generate STEMP debt tranches that are highly rated. By way of example, a STEMP series may be designed such that most of the highest-rated STEMP debt tranches are rated in the single-A category or higher to facilitate selling to all types of investors, including retail investors. Sales of lower-rated and unrated tranches can be restricted to sophisticated institutional investors and sold in minimum denominations of $100,000, for example. Investors willing to purchase lower-rated STEMP debt tranches may be concentrated among high yield bond funds, insurance companies, and municipal hedge funds, for example. Furthermore, originator(s) of pooled bonds may opt to retain lower tranches of the STEMP series, rather than selling them to new investors.

Rated tranches are likely to pay current interest while interest may accrue on lower tranches until the higher tranches are redeemed. Amortization is likely to be sequential with early maturities on the most senior tranche being redeemed first. There is likely to be liquidity reserve funded from proceeds or early revenue.

At least initially, the STEMP series debt obligations may be structured as closed cash CBOs. Each STEMP series may be composed of a static pool of fixed rate tax-exempt bonds that are in a trust held by the issuer at closing and that remain unchanged until all of the underlying bonds mature or are redeemed.

The Issuer

The structures and method described herein employ a municipal entity as the issuer of the STEMP series of debt and equity obligations. The issuer purchases tax-exempt municipal bonds from the originator(s), all of whom may be non-municipal entities. The issuer is a municipal entity authorized to issue tax-exempt bonds under U.S. law. Typically, such issuers are authorized by an enabling statute which permits the issuer to finance projects that benefit local governments, nonprofit organizations, and/or other eligible private borrowers throughout the United States. Because the STEMP series debt obligations are newly issued and secured by and paid from a pool of “collateral” (i.e., the tax-exempt bonds purchased by the issuer from the originator(s)), the STEMP series tax-exempt bonds may be thought of as the first true municipal collateralized debt obligations (municipal CDOs or muniCDOs).

The issuer may receive the pooled tax-exempt bonds from the originator(s) and may issue the STEMP series. Debt tranches of the STEMP series are provided to investors which purchase them, and such investors may include the issuer. At least a portion (e.g., 2%, 3%, or 5% or more) of the total value of the pooled bonds of the STEMP series is issued in the form of at least one equity tranche, and a portion of the equity tranche is either retained by the issuer (which is a municipality authorized to issue tax-exempt bonds) or is transferred to another municipality capable of issuing tax-exempt bonds. Pooled bonds purchased by the issuer from a non-municipal investor acting as the originator are assigned to a trust estate operated for the benefit of the holders and beneficial owners of the STEMP series.

The issuer can receive cash from investors upon sale of STEMP series obligations and/or pay cash to originators in exchange for pooled bonds. Mechanically, the cash exchanges can be handled by another party, such as a facilitator, with the issuer simply receiving the pooled bonds and issuing the corresponding STEMP series.

The Non-Municipal Investor(s)

STEMP series debt tranches or beneficial interests therein can be purchased by any investor, but given their tax-exempt status are most likely to be purchased by non-municipal investors. Such investors can be ones which have sought out opportunity to buy STEMP debt tranches, but will more typically be investors to whom or to which portions of the STEMP series have been marketed, such as by an originator, by an issuer, or by a facilitator.

One or more of the originators, and the facilitator(s) can be non-municipal investors and can purchase one or more portions of a debt tranche of the STEMP series. These parties can also purchase one or more portions of an equity tranche, so long as at least one municipal entity authorized to issue tax-exempt bonds retains a sufficient equity tranche to satisfy any regulatory or other requirement necessary to maintain the tax-exempt status of the debt tranches.

### EXAMPLES

The subject matter of this disclosure is now described with reference to the following Examples. These Examples are provided for the purpose of illustration only, and the subject matter is not limited to these Examples, but rather encompasses all variations which are evident as a result of the teaching provided herein.

### First Example of a STEMP Transaction

In an originator-instigated embodiment of the methods and structures described herein, the originator, a non-municipal investor who holds (or plans to acquire) various tax-exempt municipal bonds, provides a list of the bonds to a facilitator. Working with the originator, the facilitator creates an indicative STEMP structure, such as that illustrated in FIG. 2, including likely tranche sizes, ratings and pricing, based on the identity and characteristics of the pooled bonds and the originator's goals (e.g., sale or retention). If the indicative structure is acceptable to the originator, then the originator agrees to pay to the facilitator (or directly to other service providers) the out-of-pocket expenses to prepare the indicative STEMP series for marketing (e.g., legal and credit rating costs). At this point the originator, the facilitator and the issuer identified by the facilitator can sign an engagement letters that outline or detail transaction terms, tasks, risks, and other relevant information.

The originator agrees to proceed before the mailing of an offering document by the issuer and before the beginning of the STEMP series marketing process. At the time of this sale, the originator commits to sell the bonds into a trust held by the issuer of municipal securities at an agreed-upon price equal to the issue price of the STEMP series, minus transaction expenses (including the sales price of an equity share retained by the issuer or another government entity).

Marketing of the STEMP series proceeds, and investors are sought for the STEMP series debt obligations commences and continues until all debt obligations of the STEMP series are sold (to investors who agree to purchase them in exchange for corresponding sale prices at closing). At the closing the originator sells the bonds to the issuer for the purchase price agreed upon, and the issuer issues the STEMP debt obligations to the investors in exchange for the corresponding sale prices, and the issuer either retains the STEMP equity obligations or sells them to another government entity investor. The pool of bonds are thereafter held in trust for the benefit of the holders of the STEMP debt and equity obligations using cash flow priorities defined in the STEMP hierarchy (i.e., specified in the trust indenture) for interest, amortization, redemption, and recoveries.

### Second Example of a STEMP Transaction

A non-municipal investor that is a bond fund which invests in high-yield tax-exempt bonds, acting as the originator, sells a diversified portfolio of fifty fixed rate tax-exempt municipal bonds to an issuer authorized to issue tax-exempt bonds. The issuer places the purchased portfolio of tax-exempt bonds in a trust estate established pursuant to a trust indenture that secures a STEMP series issued by the issuer. The STEMP series includes four prioritized tranches of new fixed rate tax-exempt debt and one tranche of equity.

The three tranches of tax-exempt debt of the STEMP series with the highest payment priority are rated in investment grade categories and are sold by the issuer to new investors. The tranche of tax-exempt debt of the STEMP series with the lowest payment priority is not rated and is sold by the issuer to the originator. The equity tranche of the STEMP series is retained by the issuer. The proceeds from the sale of the tax-exempt debt of the STEMP series, less transaction costs, are paid by the issuer to the originator.

The sale of the diversified portfolio by the originator to the issuer occurs simultaneously with the sale of the STEMP series by the issuer.

### Third Example of a STEMP Transaction

A non-municipal commercial bank has made twenty-five variable rate loans to various municipalities for various governmental purposes. The interest of each of the loans is generally not subject to federal income taxation under U.S. law. The commercial bank sells the portfolio of twenty-five tax-exempt loans to an investment bank which, in turn, acting as the originator, sells the portfolio to an issuer authorized to issue tax-exempt bonds. By resolution, the issuer dedicates the purchased tax-exempt loans to secure and pay a STEMP series issued by the issuer that includes one tranche of new variable-rate tax-exempt debt and one tranche of equity.

The tax-exempt debt tranche of the STEMP series is sold by the issuer to new investors. The equity tranche of the STEMP series is sold by the issuer to a municipal investor that is capable of issuing tax-exempt bonds. The proceeds from the sale of the STEMP series, both debt and equity, less transaction costs are paid by the issuer to the originator (i.e., the investment bank).

The sale of the loan portfolio by the originator to the issuer occurs simultaneously with the sale of the STEMP series by the issuer. The sale of the loan portfolio by the commercial bank to the investment bank (i.e., the originator) occurs prior to the sale of the loan portfolio by the investment bank to the issuer.

### Fourth Example of a STEMP Transaction

A firefighting equipment company, which is a non-municipal entity, has made one hundred fixed rate loans in the form of certificates of participation to various municipalities and fire districts to finance the purchase of equipment. The interest of each of the certificates of participation is generally not subject to federal income taxation under U.S. law. The equipment company, acting as the originator, sells the portfolio of one hundred certificates of participation to an issuer authorized to issue tax-exempt bonds. The issuer places the purchased tax-exempt certificates of participation into a trust estate established pursuant to a trust indenture that secures a STEMP series issued by the issuer that includes two prioritized tranches of new tax-exempt debt and one tranche of equity.

Both of the tax-exempt debt tranches of the STEMP series are fixed rate and sold by the issuer to new investors. The equity tranche of the STEMP series is retained by the issuer. The proceeds from the sale of the tax-exempt debt of the STEMP series, less transaction costs, are paid by the issuer to the originator (i.e., the equipment company).

The sale of the certificates of participation by the originator to the issuer occurs simultaneously with the sale of the STEMP series by the issuer.

### Fifth Example of a STEMP Transaction

An investor that is a municipal hedge fund, acting as the originator, owns all of the fixed rate tax-exempt bonds funding a student housing project located on a not-for-profit university's campus. The municipal hedge fund, acting as the originator, sells the student housing project bonds to an issuer authorized to issue tax-exempt bonds. The issuer places the purchased tax-exempt bonds into a trust estate established pursuant to a trust indenture that secures a STEMP series issued by the issuer that includes two prioritized tranches of new tax-exempt debt and one tranche of equity.

The highest priority tranche of tax-exempt debt of the STEMP series is sold by the issuer as variable rate bonds to new investors. The lower priority tranche of tax-exempt debt of the STEMP series is sold by the issuer to the originator as residual interest bonds. The equity tranche of the STEMP series is retained by the issuer. The proceeds from the sale of the tax-exempt debt of the STEMP series, less transaction costs, are paid by the issuer to the originator.

The sale of the diversified portfolio by the originator to the issuer occurs simultaneously with the sale of the STEMP series by the issuer.

### Sixth Example of a STEMP Transaction

An investor that is a property and casualty insurance company owns a fixed rate tax-exempt bond with a 3% coupon. Market interest rates have increased such that the market value of the tax-exempt bond has declined below the de minimus threshold for market discounts under tax law, thereby reducing the market value of the bond. The investor, acting as the originator, sells the tax-exempt bond with a 3% coupon to an issuer authorized to issue tax-exempt bonds. The issuer places the purchased tax-exempt bond in a trust estate established pursuant to a trust indenture that secures a STEMP series issued by the issuer that includes two tranches of fixed rate tax-exempt debt and one tranche of equity. The two tranches of debt in the STEMP series are pari passu. One tranche of tax-exempt debt of the STEMP series is structured as an interest bearing bond with a 5% coupon. The other tranche of tax-exempt debt is a zero coupon bond in which interest accretes at 5.50% and is paid at maturity.

The originator purchases both tranches of tax-exempt debt of the STEMP series. The equity tranche of the STEMP series is retained by the issuer. The proceeds from the sale of the tax-exempt debt of the STEMP series, less transaction costs, are paid by the issuer to the originator.

The sale of the 3% bond by the originator to the issuer occurs simultaneous with the sale of the STEMP series by the issuer.

### Comparative Example A

One of the major reasons that municipal conduit issuers exist is to serve as a governmental conduit borrower for not-for-profit 501(c)(3) entities, including healthcare systems, for example. Qualified 501(c)(3) entities (a tax code term referring to a type of private activity bond financing) can access tax-exempt funding, but only if the obligor (the healthcare system in this example) issues the debt through a governmental entity (the conduit).

For example, when a not-for-profit healthcare system wants to borrow funds for a project in Illinois that is eligible for tax exemption, it issues a loan or bond to the Illinois Finance Authority, which simultaneously publicly sells a cash-matched tax-exempt bond. If the healthcare system wants to finance projects in different states for multiple members of its obligated group at the same time, it could have each member sell bonds to a municipal securities issuer (effectively, a multi-state government conduit) which would pool together the underlying bonds, all of them being guaranteed by the healthcare system's parent corporation. The municipal securities issuer then sells a combined issue of tax-exempt municipal bonds from a Wisconsin issuer for projects in Illinois and the other states.

The healthcare system, in this example, is a corporation that is exempt from paying income taxes but is not a unit of government. By contrast, municipal bond funds are typically not exempt from paying income taxes (and are not units of government). An innovation important to the methods and structures described herein is that they permit entities which are not exempt from taxation to employ tax exemption mechanisms available only to municipal and other tax-exempt entities in order to facilitate securitization of tax-exempt bonds in manner that previously required loss of tax exemption. This is a substantial improvement in the technological functioning of capital markets. Interest on STEMP series debt obligations are generally tax exempt because: (i) the obligations are debt of a unit of government, and (ii) all of the proceeds are invested in tax-exempt debt. Although the rationale for tax exemption is similar to that used in many pooled transactions of municipal bond banks, the structure or methods described herein are novel and non-obvious, particularly the originator being a non-municipal entity.

Under current tax law, interest on STEMP series debt obligations will generally be exempt from federal taxes and not generally subject to the alternative minimum tax (AMT). “Generally” refers, for example, to the fact that certain corporations can be subject to the AMT when holding otherwise non-AMT bonds and that the pooled bonds must not be generally subject to the AMT. Interest on STEMP series debt obligations may or may not be exempt from state and local income taxation (depending on structure and state and local tax laws).

The disclosure of every patent, patent application, and publication cited herein is hereby incorporated herein by reference in its entirety.

While this subject matter has been disclosed with reference to specific embodiments, it is apparent that other embodiments and variations can be devised by others skilled in the art without departing from the true spirit and scope of the subject matter described herein. The appended claims include all such embodiments and equivalent variations.

1. A method for managing securitization of tax-exempt bonds, the method comprising:
enabling one or more non-municipal originators to sell one or more tax-exempt bonds to a municipality for a purchase price no later than the purchase closing date;
assigning the purchased tax-exempt bonds to a pool to be held in trust for the benefit of the holders and beneficial owners of a STEMP series;
generating a proposed STEMP series including at least one equity tranche and at least one debt tranche, the proposed STEMP series;
defining the trust estate to be used to secure and pay the STEMP series as including the pool of purchased tax-exempt bonds held in trust for the benefit of the holders and beneficial owners of the STEMP series,
defining the par value for each equity and debt tranche,
defining a hierarchy among the equity and debt tranches, the hierarchy specifying entitlement of each equity and debt tranche to proceeds derived from the pooled bonds, the equity tranche being entitled to the residuum which remains after entitlements to the proceeds have been satisfied for all debt trenches, and
including a sale price for each equity and debt tranche, the sum of the sale prices for all tranches being the issue price;
enabling at least one non-municipal investor to purchase, at the corresponding sale price, at least a portion of at least one debt tranche not later than a sale closing date;
obligating at least one municipal investor to purchase or retain at least a portion of at least one equity tranche not later than the sale closing date; and
selecting an issuer authorized to issue tax-exempt bonds and enabling the issuer to issue the STEMP series to the municipal and non-municipal investors, not later than an issue closing date.

2. The method of claim 1, wherein the issuer is the municipal investor which retains the portion of the equity tranche.

3. The method of claim 1, wherein each of the purchase closing date, the sale closing date, and the issue closing date is the same date.

4. The method of claim 1, further comprising obligating the issuer to hold the pooled bonds in a trust estate operated for the benefit of all of the investors upon issuing the STEMP series.

5. The method of claim 1, wherein the municipal investor is the issuer and the municipal investor retains at least one equity tranche not later than the sale closing date.

6. The method of claim 1, wherein
each originator is enabled to sell the tax-exempt bonds to a municipality to be held in trust for the benefit of the holders and beneficial owners of the STEMP series,
each non-municipal investor is obligated to purchase the portion of at least one debt tranche,
each municipal investor is obligated to purchase or, if the municipal investor is the issuer, to retain the portion of at least one equity tranche, and
the issuer is obligated to issue the proposed STEMP series on the same date.

7. The method of claim 1, wherein each debt tranche of the STEMP series is issued in the form of one or more tax-exempt bonds.

8. The method of claim 1, further comprising,
purchasing each of the pooled bonds from the corresponding originator not later than the purchase closing date,
selling each of the pooled bonds to the issuer not later than the sale closing date,
purchasing each portion of the debt tranche of the STEMP series from the issuer not later than the issue closing date, and
selling each portion of the debt tranche of the STEMP series to the corresponding non-municipal investor not later than the issue closing date.

9. The method of claim 8, wherein
the pooled bonds are bought for the purchase price on the purchase closing date,
each portion of the debt tranche of the STEMP series is purchased from the issuer on the sale closing date, and
each portion of the debt tranche of the STEMP series is sold for the corresponding sale price to the corresponding non-municipal investor on the issue closing date.

10. The method of claim 9, wherein each of the purchase closing date, the sale closing date, and the issue closing date is the same date.

11. The method of claim 1, further comprising
brokering Sale of the pooled bonds by each originator to the issuer on the purchase closing date, and
brokering sale of each debt tranche of the STEMP series by the issuer to each non-municipal investor on the sale closing date.

12. The method of claim 1, wherein each of the pooled bonds is owned by a single originator.

13. The method of claim 1, wherein the issuer retains a portion of the STEMP series.

14. The method of claim 13, wherein the issuer retains a portion of the equity tranche.

15. The method of claim 13, wherein the issuer retains the entire equity tranche.

16. The method of claim 1, wherein at least one non-municipal investor is an originator.

17. The method of claim 1, further comprising obligating at least one of an originator, the issuer, and an investor to pay to a financial service provider at least a portion of the difference between the issue price and the purchase price.

18. The method of claim 1, further comprising securing an opinion of counsel attesting that at least one debt tranche of the STEMP series is issued in the form of a tax-exempt bond.

19. The method of claim 1, further comprising appointing a trustee to distribute proceeds realized from the pooled bonds to the investors of the STEMP series according to the hierarchy.

20. A system for managing securitization of tax-exempt bonds, the system comprising
at least one non-transient memory storage;
at least one computer processor configured to
receive and store in the storage data corresponding to a plurality of lax-exempt bonds, the data including, for each bond,
the identity of the bond and a municipality which issued it,
data confinning the bond is a tax-exempt bond, and
the identity of a non-municipal originator which Owns the debt obligation;
receive and store in the storage a proposed STEMP series including at least one equity tranche and at least one debt tranche, the proposed STEMP series
defining the par value for each equity and debt tranche,
defining a hierarchy among the equity and debt tranches, the hierarchy specifying entitlement of each equity and debt tranche to proceeds derived from the bonds, the equity tranche being entitled to the residuum which remains alter entitlements to the proceeds have been satisfied for all debt tranches, and
including a sale price for each equity and debt tranche, the sum of the sale prices for all tranches being the issue price;
receive and store in the storage a sale price for each equity and debt tranche, the sum of the sale prices of all equity and debt trenches being the issue price;
display to at least one non-municipal investor the sale price for at least a portion of at least one debt tranche;
display to at least one municipal investor the sale price for at least a portion of at least one equity tranche;
receive and store in the storage from investors offers to purchase portions of the debt and equity tranches; and
calculate the portions of each of the debt and equity tranches for which offers have been received.

21. The system of claim 20, wherein the at least one computer processor is further configured to
upon calculation that offers have been received for all portions of the debt and equity tranches,
communicate to each originator a confirmation to purchase, not later than a purchase closing date, each debt obligation owned by that seller at a purchase price,
communicate to each investor which made an offer a conformation to sell, not later than a sale closing date, each portion of it debt or equity tranche of the STENO series for which an offer was received from that investor, and
communicate to an issuer authorized to issue tax-exempt bonds a confirmation to issue, not later than an issue closing date, the proposed STEMP series to the corresponding investors.

22. The system of claim 21, wherein the at least one computer processor is further configured to
receive and store in the storage the identity of the STEMP series issued to each investor, and
calculate, according to the hierarchy, a distribution of proceeds derived from the pooled bonds among the investors.

23. The system of claim 21, wherein the at least one computer processor is further configured to manage multiple distinct rounds of securitization of discretely-pooled tax-exempt bonds.
